(19) United States
(12) Patent Application Publication
(10) Pub. No.: US 2017/0229807 A1
(43) Pub. Date: Aug. 10, 2017

(54) PLUG CONNECTOR HOUSING WITH A SEAL

(71) Applicant: HARTING Electric GmbH & Co. KG, Espelkamp (DE)

(72) Inventors: Andreas NASS, Warmsen (DE); Thomas HEIMANN, Rahden (DE); Thomas BEISCHER, Espelkamp (DE)

(21) Appl. No.: 15/504,274

(22) PCT Filed: Aug. 19, 2015
(86) PCT No.: PCT/DE2015/100346

§ 371 Date: Feb. 15, 2017

(30) Foreign Application Priority Data
Sep. 18, 2014 (DE) 10 2014 113 481.8

(51) Int. Cl. H01R 13/52; H01R 13/516

(52) U.S. Cl. CPC H01R 13/5219; H01R 13/516

(57) ABSTRACT

A plug connector housing has a connection opening for connecting the plug connector housing to a counter plug. A protective layer at least partly covers the plug connector housing, a seal lip on the connection opening protects the interior of the plug connector housing when connecting a counter plug, and a stabilizing collar, which protrudes from a wall of the plug connector housing, stabilizes the seal lip. In order to allow the plug connector housing to be easily coated and provided with a seal while preventing the formation of air pockets in the cavities of the injection molding tool, the stabilizing collar has at least one recess.

The invention relates to a plug connector housing according to the preamble of the independent main claim 1.

Plug connectors are generally known. They are usually used so as to connect cables for electrical current or electrical signals or light waves. Their housings are generally connected in a positive-locking and a non-positive locking manner.

### PRIOR ART

In order to protect plug connectors in harsh environments against mechanical loading, the plug connector housings are often spray coated at least in part with a protective layer of a synthetic material. In the case of industrial plug connectors, this coating is generally performed using the reaction injection molding (RIM-) process.

In order also to protect the contacts themselves, the plug connector housings are frequently provided in addition with a seal to provide protection against dust and moisture from outside. This seal comprises generally a sealing lip that surrounds the connection opening of the plug connector housing and seals the interior space of the plug connector housing with respect to the environment if the plug connector is connected to the mating plug. It is consequently ensured that neither dust nor moisture impair the quality of the electrical or optical connection.

The sealing lip must be connected to the plug connector housing in as mechanically stable manner as possible. DE 10 2009 038 062 A1 discloses a stabilizing collar that starting from a wall surrounds the connection opening of the plug connector housing so as to provide the sealing lip with an optimal diagonal stability.

It is usual in the case of the prior art to attach the sealing lip as a separate part by way of example by means of bonding to the plug connector housing. Alternatively, the sealing lip can be formed as one directly on the plug connector housing during the RIM process. If this is performed within the scope of coating the housing with the protective layer, the sealing lip is embodied from the same material as the protective layer of the housing, in particular from polyurethane.

In the case of the RIM process for forming the sealing lip directly on the plug connector housing, the problem arises that air bubbles form in the sealing region because the air in the injection molding tool cannot escape quickly enough. The air collects in the hollow space that is to be filled and in particular at the stabilizing collar. As a consequence, the functionality of the seal is impaired since the connection of the seal to the housing is interrupted at these sites.

### OBJECT OF THE INVENTION

The object of the present invention is to provide a plug connector housing that can be coated and provided with a seal in a simple manner without air inclusions occurring in the cavities of the injection molding tool.

This object is achieved with a plug connector housing of the type mentioned in the introduction by means of the features of the characterizing part of the independent main claim 1.

Preferred exemplary embodiments of the invention are the subject matter of the subordinate claims.

In order to reduce the likelihood of air inclusions occurring, the flow characteristics of the injected material are adjusted. The flow characteristics of the material for filling the injection molding tool can be considerably improved by virtue of the fact that the available diameter of the hollow space that is to be filled varies. The diameter is varied by means of purposefully providing interruptions or cutouts in the collar so as to stabilize the seal. Furthermore, it is possible to provide openings in the contour of the seal so as to ventilate the housing inner region. The interruptions and openings are arranged in particular in the region of the sprue and the overflow of the injection molding tool.

As a result of the improved flow characteristics, it is possible fill a larger hollow space so that in addition to coating the plug connector housing with the protective layer the seal can be formed as one simultaneously on the housing.

A separate manufacturing step is consequently omitted during the production of the plug connector housing to which the seal is attached as an independent part. Moreover, the seal is formed from the same material as the coating of the housing. Since the coating material renders it possible to provide a mechanically very robust PU coating, this also applies for the seal. Furthermore, the number of components of the plug connector housing is further reduced which, as described, reduces the number of the necessary process steps during the production of the housing (e.g. bonding) and also reduces the component and process costs. Since an additional component is omitted from the housing, this also eliminates the possibility of said component being disconnected and thus possibly becoming lost.

### EXEMPLARY EMBODIMENT

Further features and advantages are disclosed in the description hereinunder of preferred embodiments with reference to the attached drawing.

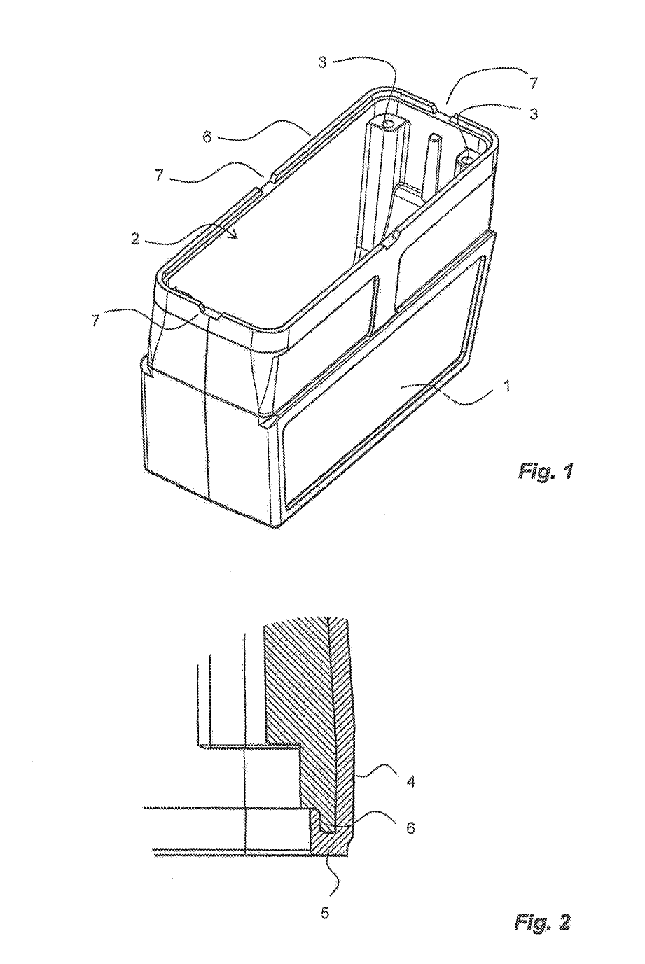

FIG. 1 illustrates a perspective view of an embodiment of the plug connector housing in accordance with the invention.

FIG. 2 illustrates a cross-sectional view of an embodiment of the plug connector housing in accordance with the invention.

The illustration in the drawing is not to scale. Like or like functioning elements are provided in the drawing with like reference numerals unless otherwise mentioned.

The plug connector housing as shown in FIG. 1 is used to connect at least two (not illustrated) conductor assemblies to one another that comprise in each case at least one conductor. The term ‘conductors’ or ‘groups of conductors’ is understood to mean in this case both electrical conductors and also fiber optic cables. The electrical conductors can be used primarily for transmitting electrical energy and also primarily for transmitting electrical signals.

The illustrated plug connector housing is only a part of the connection of conductor assemblies; the entire plug connection comprises the illustrated plug connector housing and a (not illustrated) mating plug. An end section of the respective conductor or the respective conductors is located in the plug connector housing 1. The end section is where appropriate designed especially for being connected to its mating piece, by way of example to a wire end ferrule or to a polished exit surface. So that the connection to the complementary plug connector housing can be performed, the plug connector housing 1 comprises at least one connection opening 2 for connecting the plug connector device to a mating plug. Fastening means 3 for a (not illustrated) bush and/or plug device are provided in the connection opening 2. The bush and/or plug device is arranged in a freely accessibly manner in the connection opening and is inserted into the bush and/or plug device of the mating plug or said bush and/or plug device receives said mating plug. In this manner, the desired contact is produced between the one conductor group and the other conductor group.

Plug connector devices are frequently used in harsh environments and must therefore be protected again abrasive influences. For this purpose, the plug connector housing is surrounded by a protective layer 4 that covers the plug connector housing 1 at least in part.

In order in addition to also better protect the contacts of the bush and/or plug device in the connection opening 2 after the assembly process, the edge of the connection opening 2 is provided with a sealing lip 5. The sealing lip 5 is pressed again the mating plug when the two devices are assembled together. As a consequence, the intermediate space between the plug connector device and the mating plug is sealed.

FIG. 2 illustrates a cross-sectional view of the sealing lip 5. In the case of the embodiment illustrated in FIG. 2, the sealing lip 5 is formed as one piece on the protective layer 4 of the plug connector housing 1, in other words there is no noticeable transition between the protective layer 4 and the sealing lip 5.

So that the sealing lip 5 is fixedly connected to the wall of the connection opening 2 and does not easily slip off said wall, the plug connector housing 1 is provided on its connection opening 2 with a stabilizing collar 6 that starting from the wall of the plug connector housing 1 extends in the direction of the (not illustrated) mating plug.

As is evident in FIG. 2, the sealing lip 5 encompasses the collar 6 and fills the space on the inner side of the collar directly at the connection opening 2.

In order to improve the flow characteristics of the synthetic material that is pressed into the molding tool so as to form the protective layer 4 and the sealing lip 5, the stabilizing collar 6 comprises at least one notch 7. The stabilizing collar 6 is illustrated in FIG. 1 with multiple notches 7. The embodiment in FIG. 1 comprises in total four notches 7 in the stabilizing collar 6. Said notches are arranged in pairs lying diametrically opposite one another. The invention is however not limited to this embodiment and other geometric arrangements are readily feasible.

Generally speaking, it is advantageous if the at least two notches 7 are distributed in the stabilizing collar uniformly along the periphery of the connection opening 2. It is likewise advantageous if the at least two notches 7 in the stabilizing collar 6 lie in pairs diametrically opposite one another with regard to the connection opening 2.

In addition to the number of recesses 7 and the type of distribution along the edge of the connection opening 2, it is also possible to vary the shape of the notch for the flow characteristics. Thus, in a further, not illustrated embodiment of the invention, the transition between the stabilizing collar 6 and a notch 7 is chamfered.

The invention can be used in any type of housing. This relates in particular to the material of the housing but also to the material for the protective layer 4 and the sealing lip 5. Thus, the plug connector housing 1 can be a metal cast housing and in particular an aluminum housing or a zinc pressure cast housing but also the invention can be used in the case of a housing that is formed from a sheet-metal bent part.

The material for the protective layer 4 and the sealing lip 5 is in particular a polyurethane compound.

The described features render it possible to apply the coating at the same time as the housing seals. The ventilation at the stabilizing collar of the molded-on seal during the coating process is enhanced by the proposed contours (notches) on the collar.

### Plug Connector Housing With a Seal

### LIST OF REFERENCE NUMERALS

1 Plug connector housing

2 Connection opening

3 Fastening means for the bush and plug device

4 Protective layer

5 Sealing lip

6 Stabilizing collar

7 Notch

1. A plug connector housing comprising
a connection opening for connecting the plug connector housing to a mating plug;
a protective layer that covers the plug connector housing at least in part;
a sealing lip on the connection opening so as to protect the inner space of the plug connector housing when connecting a mating plug; and
a stabilizing collar for stabilizing the sealing lip that extends starting from a wall of the plug connector housing,
wherein
the stabilizing collar comprises at least one notch.

2. The plug connector housing as claimed in claim 1, wherein multiple notches in the stabilizing collar are distributed uniformly along a periphery of the connection opening.

3. The plug connector housing as claimed in claim 1, wherein in each case two of the multiple notches in the stabilizing collar lie diametrically opposite one another with regard to the connection opening.

4. The plug connector housing as claimed in claim 1, wherein the transition between the stabilizing collar and a notch is chamfered.

5. The plug connector housing as claimed in claim 1, wherein the plug connector housing is a metal cast housing.

6. The plug connector housing as claimed in claim 5, wherein the metal cast housing is an aluminum housing.

7. The plug connector housing as claimed in claim 5, wherein the metal cast housing is a zinc pressure cast housing.

8. The plug connector housing as claimed in claim 1, wherein the plug connector housing is a housing that is formed from a sheet-metal bent part.

9. The plug connector housing as claimed in claim 1, wherein the protective layer comprises a polyurethane compound.

10. The plug connector housing as claimed in claim 2, wherein the plug connector housing is a metal cast housing.

11. The plug connector housing as claimed in claim 10, wherein the metal cast housing is an aluminum housing.

12. The plug connector housing as claimed in claim 10, wherein the metal cast housing is a zinc pressure cast housing.

13. The plug connector housing as claimed in claim 3, wherein the plug connector housing is a metal cast housing.

14. The plug connector housing as claimed in claim 13, wherein the metal cast housing is an aluminum housing.

15. The plug connector housing as claimed in claim 13, wherein the metal cast housing is a zinc pressure cast housing.

16. The plug connector housing as claimed in claim 4, wherein the plug connector housing is a metal cast housing.

17. The plug connector housing as claimed in claim 16, wherein the metal cast housing is an aluminum housing.

18. The plug connector housing as claimed in claim 16, wherein the metal cast housing is a zinc pressure cast housing.
